(19) United States
(12) Patent Application Publication
(10) Pub. No.: US 2012/0275892 A1
(43) Pub. Date: Nov. 1, 2012

(54) Industrial truck with a height-adjustable load support

(75) Inventors: Uwe Allerding, Embsen (DE); Christoph Behncke, Bad Segeberg (DE); Matthias Duewel, Norderstedt (DE)

(73) Assignee: JUNGHEINRICH AKTIENGESELLSCHAFT, Hamburg (DE)

(21) Appl. No.: 13/457,913

(22) Filed: Apr. 27, 2012

(30) Foreign Application Priority Data
Apr. 29, 2011 (DE) 10 2011 100 913.6

(51) Int. Cl. B66F 9/12; B66F 9/06

(52) U.S. Cl. 414/663; 187/222

(57) ABSTRACT

An industrial truck with a load support which is adjustable in its height along a lifting frame and whose taken load is detected by a load sensor, wherein a control unit is provided in which one or several load gravity centres can be selected and which determines an admissible lifting height for the one or several selected load gravity centres on the basis of the detected load.

### CROSS-REFERENCE TO RELATED APPLICATIONS

Not applicable

### STATEMENT REGARDING FEDERALLY SPONSORED RESEARCH

Not applicable

### BACKGROUND OF THE INVENTION

The present invention relates to an industrial truck having a load support which is adjustable in its height along a lifting frame and whose taken load is detected by a load sensor.

It is known to attach an easily readable load capacity chart on an industrial truck having a height-adjustable load support, which informs the driver about which load may be lifted up to which height in order to avoid or to reduce any danger of overturn for vehicles. The load capacity chart shows the maximum admissible load for different distances of the load gravity centre and for different lifting heights, depending on the type of the vehicle. The load capacity chart is frequently realised in the form of a matrix, whose rows indicate the admissible lifting heights and whose columns indicate the load gravity centre distances, wherein the cells of the matrix show the admissible maximum weight.

In the utilisation of a load capacity chart, the operator has to determine the correct load gravity centre, detect the load, estimate the height of stacking in/out, and to read out the maximum admissible load in the correct row and column of the chart on the basis of these values. The vehicle operator must compare the thus obtained numerical value for the maximum admissible load with his/her estimated load value, in order to decide whether there is a danger of overturn.

It is further known to perform automatic determination of the overturn limit of industrial trucks from the load, the lifting height, the thrust position, the inclination position, the load gravity centre and the vehicle gravity centre and further vehicle-specific input variables. In doing so, a mathematical method for automatic determination of the overturn limit is cyclically calculated by a control device. Because the input variables used in this are affected by tolerance since they are measured values, such methods yield a significantly too high safety distance from the physical turnover limit. Using sensors with little tolerance is comparably sumptuous, so that as a result, the driver is warned too early and without necessity.

The present invention is based on the objective to provide an industrial truck which reliably determines the safety distance from the physical overturn limit of the vehicle that must be observed using as few sensors as possible.

The industrial truck of the present invention is equipped with a load support which is adjustable in its height along a lifting frame. The industrial truck is further equipped with a load sensor, which detects the weight of a load taken on the load support. The industrial truck of the present invention has a control unit, in which one or several load gravity centres can be selected manually by the driver. The control unit according to the present invention determines an admissible lifting height for the selected load gravity centre(s) on the basis of the detected load. Preferably, the control unit indicates the determined admissible lifting height to the driver. The control unit of the present invention enables the driver to reliably determine a maximum lifting height by selecting one or several load gravity centres which indicate the distance of the load gravity centre from a rear side of the load support, for instance. This means that the control unit according to the present invention can reliably determine a maximum lifting height using only one load sensor, and can inform the driver about this lifting height or initiate further steps. The selection of one load gravity centre is preferred.

### BRIEF SUMMARY OF THE INVENTION

In a preferred extension, a height sensor for the load support is provided in addition, which applies a detected lifting height to the control unit. By this additional information, the control unit can generate an optical and/or acoustic alarm signal when the detected lifting height falls below a predetermined minimum distance to the determined maximum admissible lifting height. In this embodiment, it is important, that the lifting height sensor is not used to calculate a tilting moment in a mathematical model, but only for generating alarm signals when the lifting height approaches a determined maximum lifting height. In spite of the second sensor, the control unit of the industrial truck according to the present invention works with one load sensor only in order to determine the maximum admissible lifting height.

In a preferred extension, the alarm signal changes with increasing approach of the load support to the maximum admissible lifting height. Thus, the operator can be warned that a critical situation is imminent for the industrial truck if the lifting of the load support is continued.

In a further embodiment, which is relevant for reach mast trucks in particular, a thrust sensor is provided which applies a detected position of the reach mast to the control unit. In a reach mast truck, the lifting frame is provided on a reach mast holder in order to be shifted in the region between the wheel arms.

In a preferred embodiment, the control unit determines the admissible lifting height depending on the detected position of the reach mast.

In a preferred embodiment, the control unit is realised to select a desired lifting height in addition, and to determine and display the maximum liftable load for the desired lifting height for the selected load gravity centre. In this embodiment of the control unit, the operator of the industrial truck can detect in a very simple manner whether a desired height for stacking in and out is possible for a taken load, or whether it can lead to a critical situation.

### BRIEF DESCRIPTION OF THE SEVERAL VIEWS OF THE DRAWINGS

A preferred realisation example is explained in more detail in the following.

FIG. 1 shows a reach mast truck in a perspective view from the side,

FIG. 2 shows a simplified view of a control unit, and

FIG. 3 shows a schematic view concerning signal processing.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

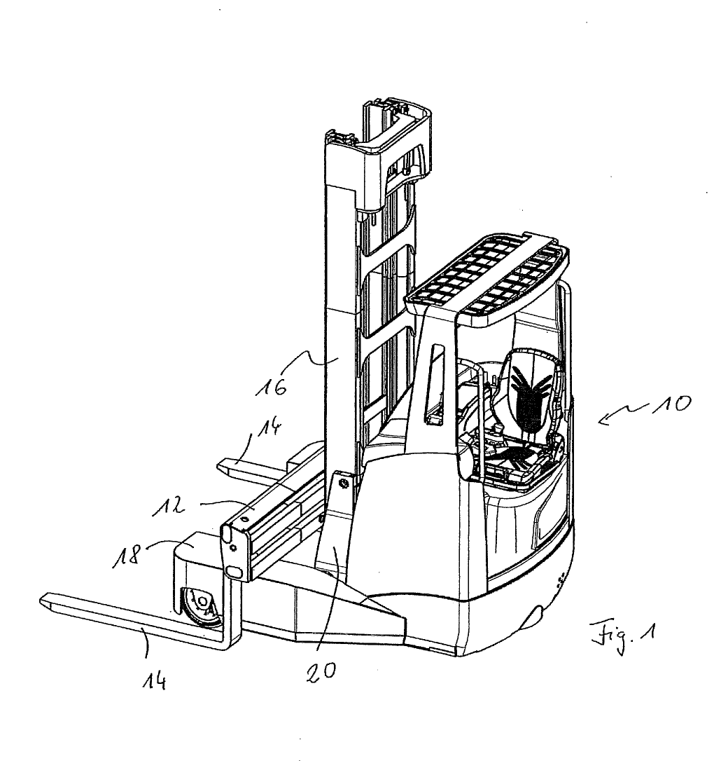

FIG. 1 shows a reach mast truck 10 in a perspective view from the side, which is equipped with a tooth adjustment device 12 as a load support. The tooth adjustment device 12 has two fork teeth 14, which can be adjusted horizontally along the tooth adjustment device. The tooth adjustment device 12 can be shifted in its height along the lifting mast 16, wherein the lifting mast 16 can be telescopically extended in its mast lifting. On the load side, the industrial truck is supported by a pair of wheel arms 18. The lifting mast 16 can be thrust forward and back along the wheel arms via a mast holder 20.

The lifting mast 16 is equipped with an analogue pressure sensor (not shown), which detects the weight force of a taken load exercised to the fork teeth 14. As an alternative to a pressure sensor, it is also possible to use indirect systems for determining the actual load weight, in which for instance an estimation based on the electrical current consumed by the pump motor is used to determine the weight of the load.

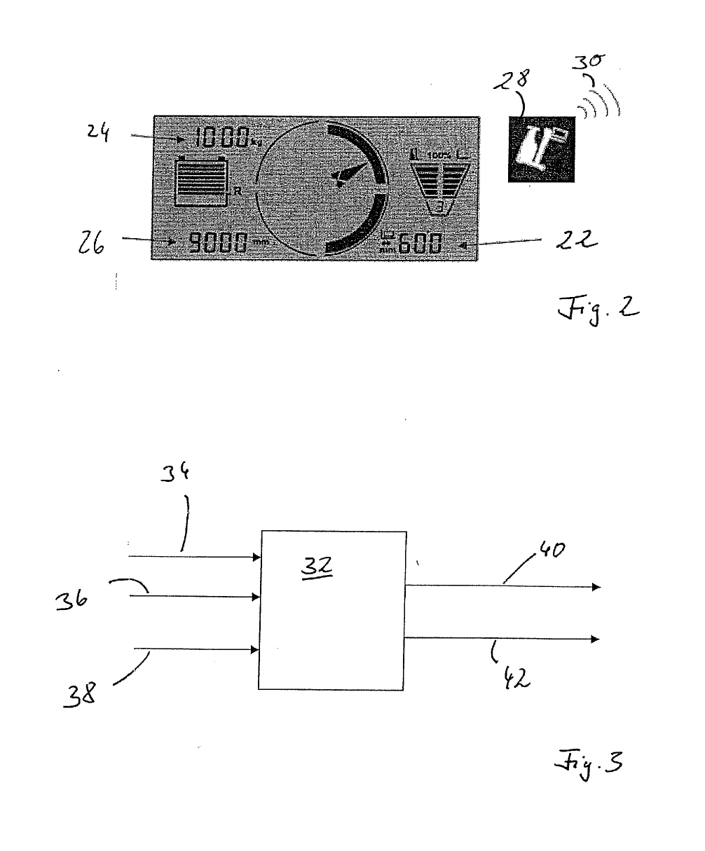

FIG. 2 shows a display- and input unit of the control device according to the present invention in a simplified depiction. At the lower right side in the field 22, the load gravity centre can be input by means of the control device. For this purpose, one distinguishes between three different load gravity centres, the middle load gravity centre being present when a load having uniform weight distribution is completely positioned on fork tooth 14. A load gravity centre at the vehicle side can be shifted at the vehicle side about 10 cm to the middle load gravity centre, for instance. This gravity centre at the vehicle side can be selected when a load has been completely taken on the fork teeth 14, but does not extend in its depth over all the fork teeth, so that with respect to the overall length of the fork teeth, the load rests on the fork teeth 14 rather at the vehicle side. The load gravity centre at the load side can be 10 cm farther away from the vehicle body, for instance, than the middle load gravity centre. The load gravity centre at the load side can be selected when a load can not be taken on the fork teeth completely, or the load can be taken only with a front section of the fork teeth.

Besides to the three load gravity centres described above, even further load gravity centres can be provided in the control unit of the present invention. However, with regard to ergonomic operation of the control unit, it is sufficient to provide three load gravity centres. The load gravity centre estimated by the driver can be input on the control panel 22 and is subsequently indicated to the driver. If the driver forgets to put in a load gravity centre, the system is set to the least favourable case, i.e. to a load gravity centre far away from the vehicle body.

The weight of the taken load is displayed via display field 24. The necessary values for this are provided by the load sensor.

Field 26 shows the real value of the lifting height, as detected by the lifting height sensor. As an alternative, it is also possible to switch the display of the control unit such that not the real value of the lifting height is displayed in field 26 but the admissible maximum value of the lifting height, which results from the value for the load 24 and the load gravity centre 22 which is set.

When the control unit detects that the load support is lifted to a lifting height that falls below a predetermined minimum distance to the maximum lifting height of for instance 1 m, an alarm signal 28 is generated. The alarm signal 28 can for instance twinkle on the control panel, and thus warn the driver not to exceed the maximum lifting height. In addition it is also possible that an alarm sound 30 is generated, which varies for instance in loudness and/or tone pitch the more the real lifting height approaches the admissible lifting height.

In a schematic view, FIG. 3 shows the signal processing in the control unit 32. The measured lifting height of the load support is applied to the control unit 32 via a connector 34. The load weight from the load sensor is applied to the control unit 32 via the connector 36. The input load gravity centre is applied to the control unit 32 via the input port 38. The control unit 32 determines the admissible lifting height from the applied values of load gravity centre and load weight and compares it with the applied real value of the lifting height. If it is detected that a minimum distance of the lifting height from the maximum lifting height has fallen below, an optical alarm signal is generated via connector 40, and an acoustic alarm signal via connector 42.

In the calculation of the maximum admissible lifting height, the control unit works with the aid of predetermined values, which are determined specifically for the vehicle having a lifting frame. Thus, the maximum admissible is deposited in the control unit for each one of the possible load distances for several lifting heights at a time. By interpolating the deposited values, the maximum lifting height can then be determined for the real value of the taken load. This method does not require any sumptuous mathematical calculations, and in so far it is simple and reliable.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. An industrial truck with a load support (12) which is adjustable in its height along a lifting frame (16) and whose taken load is detected by a load sensor, comprising:
a control unit (32) is provided in which one or several load gravity centres can be selected and which determines an admissible lifting height for the one or several selected load gravity centres on the basis of the detected load.

2. The industrial truck according to claim 1, characterised in that a lifting height sensor for the load support is provided in addition, which applies the detected lifting height to the control unit (32).

3. The industrial truck according to claim 2, characterised in that the control unit generates an optical and/or acoustic alarm signal when the detected lifting height falls below a predetermined minimum distance to the admissible lifting height.

4. The industrial truck according to claim 3, characterised in that the alarm signal changes when the lifting height increasing approaches the admissible lifting height.

5. The industrial truck according to claim 1, characterised in that the lifting frame is provided on a reach mast and a thrust sensor applies a detected position of the reach mast to the control unit.

6. The industrial truck according to claim 5, characterised in that the control unit determines the admissible lifting height depending on the detected position of the reach mast.

7. The industrial truck according to claim 1, characterised in that a desired lifting height can be selected in the control unit in addition, and the control unit determines and displays the maximum liftable load for the desired lifting height for the selected load gravity centre.
